(19) United States
(12) Patent Application Publication
(10) Pub. No.: US 2006/0148405 A1
(43) Pub. Date: Jul. 6, 2006

(54) Bluetooth audio relay

(75) Inventors: I-Tung Wu, Taipei City (TW); Jian-Hua Chen, Jhonghe City (TW); Chi-Jung Tsai, Taipei City (TW); Bor-Kuan Lu, Bade City (TW); Chung-Chun Wu, Taipei City (TW)

Correspondence Address: KUSNER & JAFFE;HIGHLAND PLACE SUITE 310, 6151 WILSON MILLS ROAD, HIGHLAND HEIGHTS, OH, 44143, US

(73) Assignee: AboCom Systems, Inc.

(21) Appl. No.: 11/110,026

(22) Filed: Apr. 20, 2005

(30) Foreign Application Priority Data
Jan. 4, 2005 (TW) 094100187

(51) Int. Cl. H04B 7/00

(52) U.S. Cl. 455/41.2

(57) ABSTRACT

The present invention discloses a Bluetooth audio relay, which comprises: a printed circuit board (PCB); a Bluetooth chip mounted on the PCB for processing the Bluetooth signals and transforming the Bluetooth signals into digital audio signals; an antenna coupled to the Bluetooth chip for receiving and transmitting the Bluetooth signals, and transferring the Bluetooth signals to the Bluetooth chip; memory mounted on the PCB and coupled to the Bluetooth chip for storing digital data; a power supply coupled to the Bluetooth ship for providing power; a codec chip mounted on the PCB and coupled to the Bluetooth chip for transforming the digital audio signals into analog audio signals; and a plurality of audio jacks mounted on the PCB and coupled the codec chip for outputting the analog audio signals

### FIELD OF THE INVENTION

The present invention is related to an audio relay, particularly to an audio signal relay using the Bluetooth protocol.

### BACKGROUND OF THE INVENTION

Bluetooth is a communication standard with opening structure, which enables the personal computer, the notebook, the PDA, the cellular phone, the printer, the scanner, the digital camera and the household appliances to link to each other within a short distance. Bluetooth utilizes the global public channel (2.4 GHz) to ensure the unobstructed application. In conclusion, various digital devices could wirelessly communicate with each other, and the desk disorderly spread with cables would therefore become neat and tidy.

The conventional Bluetooth headset could merely receive the audio content transmitted in Bluetooth signals and play the audio content directly. The user, however, can not expand the applications of such type of Bluetooth headset, and needs to stand the poor audio effect. In addition, the manufacture cost of this type of Bluetooth headset is much higher than that of conventional wired headset because of the built-in earphone. The popularization of the Bluetooth headset is therefore obstructed. To reach the market scale with sufficient economical benefits, the Bluetooth products having the advantages of expandability, mobility and low-cost should be provided immediately.

### SUMMARY OF THE INVENTION

In view of the aforementioned problems, the present invention provides a Bluetooth audio signal relay with high expandability, mobility and economical manufacture cost. With the Bluetooth audio signal relay of the present invention, the user could utilize the plural audio jacks (earphone jacks) therein to relay the wireless audio signals of a call or the music to various players. Moreover, the players may be any possible kinds of earphones, speakers or audio equipments with amplifiers. Through the Bluetooth audio signal relay, the player could wirelessly receive the audio signals without any built-in Bluetooth transmitter.

According to one purpose of the present invention, a Bluetooth audio signal relay is disclosed. The Bluetooth audio signal relay comprises a printed circuit board (PCB) and a Bluetooth chip mounted thereon for processing Bluetooth signals and transforming the Bluetooth signals into digital audio signals. An antenna coupled to the Bluetooth chip for receiving or transmitting Bluetooth signals and transferring the Bluetooth signals to the Bluetooth chip. The Bluetooth audio signal relay also comprises the memory mounted on the PCB and coupled to the Bluetooth chip for storing digital data. A power supply coupled to the Bluetooth chip provides the power, and the codec chip mounted on the PCB and coupled to the Bluetooth chip is applied to transform the digital signals into analog signals. The Bluetooth audio signal relay further comprises a plurality of audio jacks mounted on the PCB and coupled to the codec ship for outputting analog audio signals.

### BRIEF DESCRIPTION OF THE DRAWINGS

FIG. 1 is the block diagram of the present invention.

FIG. 2 is the outward appearance of the present invention.

FIG. 3 is the outward appearance of the present invention.

FIG. 4 is the outward appearance of the present invention.

### DETAILED DESCRIPTION OF THE PREFERRED EMBODIMENT

The present invention is described with the preferred embodiments and accompanying drawings. It should be appreciated that all the embodiments are merely used for illustration. Although the present invention has been described in terms of a preferred embodiment, the invention is not limited to this embodiment. The scope of the invention is defined by the claims. Modifications within the spirit of the invention will be apparent to those skilled in the art.

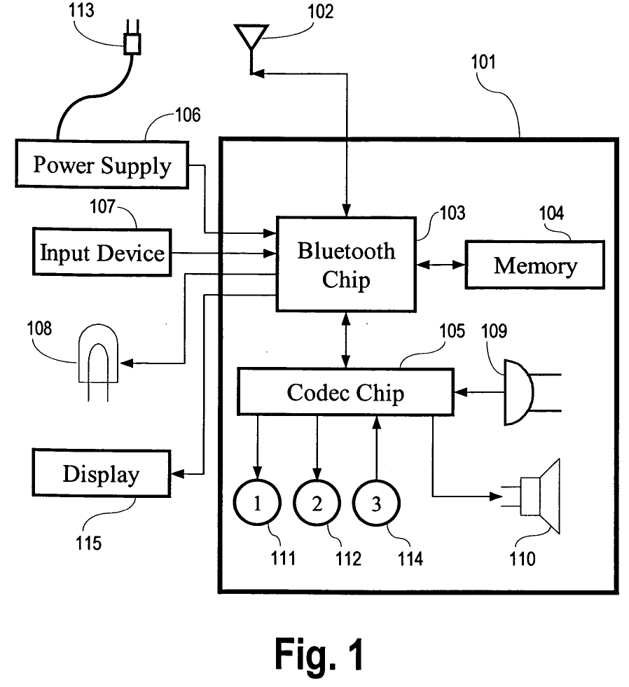

Referring to FIG. 1, a block diagram shows the preferred embodiment of the Bluetooth audio signal relay of the present invention. It should be noted that all the possible elements of the present invention are illustrated, but not every element in the drawing is essential.

Most main elements could be mounted on a printed circuit board (PCB) 101, but there are some elements not mounted on PCB 101 in FIG. 1. However, in another embodiment of the present invention, all of the elements may be mounted on the PCB. It should be noted that the present invention should encompass every possible way to assemble the elements. According to the preferred embodiment of the present invention, a Bluetooth chip 103, memory 104, a codec chip 105, a microphone 109, a speaker 110 and audio jacks 111, 112 are mounted on PCB 101.

An antenna 102 is applied to transmit and receive the Bluetooth signals. In the preferred embodiment of the present invention, the Bluetooth audio relay may pair with a plurality of devices. As the Bluetooth audio signals come from the paired audio source wirelessly, the antenna 102 would transfer these signals to the Bluetooth chip 103, such as the commercial product ZV4301 of Zeevo® or BC3-MM of CSR®, which is preferably able to process the stereo signals. Other Bluetooth chip which can process only the mono audio signals may also be adopted in another embodiment of the present invention.

The Bluetooth chip 103 would transform the received Bluetooth signals into digital audio signals, and transfer them to the codec chip 105. The codec chip 105 is coupled to the Bluetooth chip 103 and applied to transform the digital audio signals into analog audio signals. The analog audio signals then are outputted via an earphone or a speaker. Various available codec chips 105 could be adopted in the present invention, such as the commercial product WM8731 of Wolfson® or DAC CS4340 of Cirrus Logic®. The present invention may comprise a speaker 110 coupled to the codec chips 105, and the speaker 110 could be a normal earphone or speakerphone. However, the Bluetooth audio signal relay is preferably not equipped with any built-in earphone or speaker to improve the mobility and reduce the manufacture cost of the Bluetooth audio signal relay. Besides, plural audio jacks 111, 112 are applied as the main audio output port to replace the built-in earphone or speaker. Although there are merely two audio jacks illustrated in FIG. 1, the number of the audio jacks is not limited to two and could be modified according to various situations or demands. In general, the number of audio jacks is based on the support of the codec chip 105 and the consideration of manufacture cost.

Besides, the audio jacks of the present invention preferably include at least one audio out jack for directly connecting the earphone or other speaker devices. According to another embodiment of the present invention, the audio jacks may further include at least one line out jack for connecting with the audio equipment with an amplifier, and therefore the Bluetooth audio signal relay could work as a music streaming device. In addition, the Bluetooth audio signal relay is preferably controlled wirelessly by a computer or MP3 player with a (built-in or external) transmitter. It should be noted that the Bluetooth audio signal relay can include every possible collection of various audio jacks. Moreover, the present invention may further includes a line in jack for transforming external analog audio signals into Bluetooth signals and wirelessly transmitting these transformed signals to other Bluetooth devices. The aforementioned examples of audio jacks are described for illustration, instead of limitation.

A microphone 109 could be included in the Bluetooth audio signal relay of the present invention and coupled to the codec chip 105. In this situation, the Bluetooth audio signal relay may be applied as a hand-free device of a cellular phone. However, the Bluetooth audio signal relay may have no built-in microphone or merely provide a microphone jack to connect an external microphone. The microphone 109 and the speaker 110 are both optional elements, which can be added or omitted on demand. Besides, a user may vocally and wirelessly dial someone by using the microphone 109 of the Bluetooth audio signal relay.

The memory 104 is mainly applied for storing plural programs or the phone book. Typically, the memory 104 is coupled to the Bluetooth chip 103 also. The operation of the Bluetooth chip 103 may base on these programs, and the call information may be displayed according to the data of phone book. The programs include the audio controlling program, the hand-free program and the switch program. Besides, the Bluetooth audio signal device could include a built-in display 115 to display the call information, wherein the display 115 may be a liquid crystal display (LCD) or a light emitting diode displayer (LED displayer). The call information may be provided by the cellular phone or depend on the phone book in the memory. Moreover, if the memory 104 keeps data of phone book, the user is able to wirelessly dial certain phone number in the phone book by using the input device 107, such as keys or buttons. The types of the display 115 are not limited to the above examples, but may further include other light or power-saving display means. The aforementioned types of the display are enumerated merely for illustration, instead of limitation. The present invention could include various kinds of memory, such as flash memory, read only memory (ROM) or random access memory (RAM). However, the flash memory is the preferred choice, such as the current commercial product SST39VF800A of SST® or AT49BV802A of ATMEL®.

The audio controlling program is applied to enable the Bluetooth audio signal relay to process the stereo signals, and the hand-free program is applied to enable the Bluetooth audio signal relay to operate as a hand-free device of a cellular phone. Since the Bluetooth audio signal relay may pair with plural Bluetooth devices, for example, the media player (PC) and the cellular phone, the switch program is applied to enable the Bluetooth chip 103 to switch from one mode to another, manually or automatically. For instance, a calling signal is provided to the Bluetooth audio signal relay as the cellular phone receives the call. The Bluetooth chip 103 in the Bluetooth audio signal relay would automatically switch the headset mode to the hand-free mode by the switch program in the memory 104. Besides, the hand-free mode would be switch back to the headset mode after the call is finished.

In another embodiment of the present invention, the Bluetooth audio signal relay may comprise an input device 107 coupled to the Bluetooth chip 103 for providing external instructions to the Bluetooth chip 103. The input device 107 may be the keys or buttons on the casing of the relay, or the built-in microphone 109 with vocal input ability. Besides, the switch program of the relay could also switch the modes manually with various input devices 107.

The power supply 106 is preferably a battery, especially a rechargeable battery, such as the Lithium Ion (Li-ion) battery, the Nickel Metal Hydride (Ni-MH) battery, the Nickel Cadmium (Ni—Cd) or the Lithium Polymer battery. Besides, the relay may also comprise an external power port 113 on the casing. The external power port 113 is an optional element and not essential to the present invention, and could therefore be omitted on user's demand or commercial considerations. For example, the external power port 113 may be an electric plug for providing power to operate the relay or charge the chargeable battery.

The Bluetooth audio signal relay may further include an indicator light 108 coupled to the Bluetooth chip 103 for indicating the operation or linking status. Similarly, the indicator light 108 is an optional element and could be added or omitted on demand.

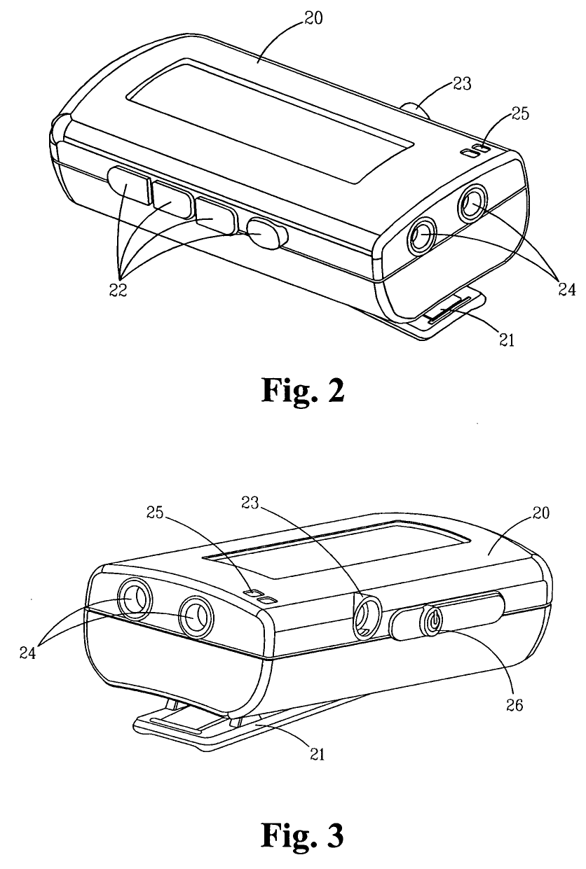

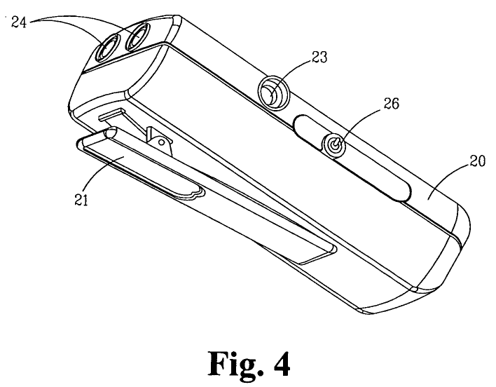

FIG. 2 through FIG. 4 illustrate the casing 20 of the Bluetooth audio signal relay. As we can see, the relay may comprise a back splint 21 to fix the relay on the collar, the pocket or the cuff of the clothes, and therefore increase the mobility and convenience. Moreover, the indicator 25 (corresponding to No. 108 in FIG. 1) is used to indicate the linking or operation status, and plural keys or buttons 22 are included in the input devices 107 of the relay. The casing 20 may have an opening 23 corresponding to the external power port 113, and the circle openings 24 correspond to the audio jacks 111, 112. The button 26 is used to power on and power off the relay. It should be noted that there are two phone jacks 24, five keys 22, 26 and two indicator lights 25 in the outward appearances, but they are presented and described for illustration, instead of limitation. The present invention is not limited to the aforementioned embodiments and the drawings, but should encompass any possible combination of these elements.

The present invention operates as the audio relay for any audio device with Bluetooth transceiver, such as the computer, the portable flash drive, the MP3 player, the television, the hi-fi equipment or the PDA. The audio source of the Bluetooth audio signal relay should include every audio device with built-in or external Bluetooth transceiver (the Bluetooth dangle). In addition, the input device, such as keys or buttons, of the present invention may also be applied as the remote control of the audio devices. For example, the user may use the Bluetooth audio signal relay to control the MP3 player to play, stop, pause, forward or rewind the songs, and the controlling program in the memory 104 is required to achieve such function.

Since the Bluetooth protocol is a non-directional wireless communication standard, the present invention possesses the advantage of high mobility, and is not restricted to certain fixed direction. In addition, the present is dissimilar to the normal Bluetooth earphone which is only able to receive and play the audio content, but could relay the audio signals to any external speaker or normal earphone. Hence, the present invention possesses advantage of high expandability. Besides, the earphone or speaker may be omitted, so the Bluetooth audio signal relay is lighter and smaller than the conventional Bluetooth earphone. In addition, since the power consuming is relatively low in the Bluetooth device, the weight of battery therein is reduced, and the duration of usage is therefore prolonged. In conclusion, the manufacture cost of the present invention would be remarkably reduced because no built-in earphone is required. Accordingly, the marketing competitiveness of the Bluetooth audio signal relay is highly raised. The user could appreciate the music in every environment by any convenient device without the limitation of built-in earphone or speaker.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

We claim:

1. A Bluetooth audio signal relay, which comprises:
a printed circuit board (PCB);
a Bluetooth chip mounted on said printed circuit board for processing Bluetooth signals and transforming said Bluetooth signals into digital audio signals;
an antenna coupled to said Bluetooth chip for receiving or transmitting said Bluetooth signals to said Bluetooth chip;
memory mounted on said printed circuit board and coupled to said Bluetooth chip for storing digital data;
a power supply coupled to said Bluetooth chip for providing power;
a codec chip mounted on said printed circuit board and coupled to said Bluetooth chip for converting between said digital audio signals and analog audio signals; and
a plurality of audio jacks mounted on said printed circuit board and coupled to said codec ship for outputting said analog audio signals.

2. The Bluetooth audio signal relay as set forth in claim 1, which further comprises a microphone coupled to said codec chip.

3. The Bluetooth audio signal relay as set forth in claim 2, wherein said memory includes a switch program to switch said Bluetooth audio signal relay to a hand-free mode.

4. The Bluetooth audio signal relay as set forth in claim 2, wherein said memory includes a hand-free program for applying said Bluetooth audio signal relay as a hand-free device with the ability for dialing.

5. The Bluetooth audio signal relay as set forth in claim 4, which further comprises a display for displaying information.

6. The Bluetooth audio signal relay as set forth in claim 5, wherein said memory stores phone book data, and said call information bases on said phone book data.

7. The Bluetooth audio signal relay as set forth in claim 5, wherein said call information comes from a cellular phone.

8. The Bluetooth audio signal relay as set forth in claim 1, wherein said memory includes an audio controlling program for enabling said Bluetooth to process stereo signals.

9. The Bluetooth audio signal relay as set forth in claim 1, which further comprises an input device for inputting instructions to said Bluetooth chip.

10. The Bluetooth audio signal relay as set forth in claim 1, wherein said plurality of audio jacks includes at least one speaker out jack.

11. The Bluetooth audio signal relay as set forth in claim 1, wherein said plurality of audio jacks includes at least one line out jack for streaming audio data, and said Bluetooth audio signal relay is controlled wirelessly by a Bluetooth device or a computer.

12. The Bluetooth audio signal relay as set forth in claim 1, wherein said memory includes flash memory.

13. The Bluetooth audio signal relay as set forth in claim 1, wherein said memory includes read only memory (ROM).

14. The Bluetooth audio signal relay as set forth in claim 1, wherein said memory includes random access memory (RAM).

15. The Bluetooth audio signal relay as set forth in claim 1, which further comprises an indicator light coupled to said Bluetooth chip for indicating linking statuses.

16. The Bluetooth audio signal relay as set forth in claim 1, which further comprises a speaker for playing said analog audio signals.

17. The Bluetooth audio signal relay as set forth in claim 1, wherein said power supply includes a rechargeable battery.

18. The Bluetooth audio signal relay as set forth in claim 17, which further comprises an external power port for providing power or charging said rechargeable battery.

19. The Bluetooth audio signal relay as set forth in claim 1, wherein said casing includes a back splint mounted on a casing of said Bluetooth audio signal relay.

20. The Bluetooth audio signal relay as set forth in claim 1, wherein a plurality of keys on a casing of said Bluetooth audio signal relay for inputting instructions to said Bluetooth chip.
